(19) United States
(12) Patent Application Publication
(10) Pub. No.: US 2020/0106529 A1
(43) Pub. Date: Apr. 2, 2020

(54) OPTICAL RECEIVER, OPTICAL TRANSMITTER, DATA IDENTIFICATION METHOD, AND MULTILEVEL COMMUNICATION SYSTEM

(71) Applicant: Mitsubishi Electric Corporation, Tokyo (JP)

(72) Inventors: Seiki NAKAMURA, Tokyo (JP); Mizuki SHIRAO, Tokyo (JP)

(73) Assignee: Mitsubishi Electric Corporation, Tokyo (JP)

(21) Appl. No.: 16/604,871

(22) PCT Filed: Jun. 21, 2017
(86) PCT No.: PCT/JP2017/022885

§ 371 Date: Oct. 11, 2019

(51) Int. Cl. H04B 10/54; H04B 10/69

(52) U.S. Cl. CPC H04B 10/54; H04B 10/69

(57) ABSTRACT

An optical receiver to receive a multilevel modulation signal in which a value of transmission data is assigned to plural signal levels, the optical receiver including a clock generator to generate a recovered clock signal from the multilevel modulation signal when the clock generator detects that a signal level of the multilevel modulation signal transitions between two median levels of the signal levels, and a data identifier to identify a value of the transmission data by using the generated recovered clock signal and the multilevel modulation signal.

### FIELD

The present invention relates to an optical receiver, an optical transmitter, a data identification method, and a multilevel communication system which use a multilevel modulation method.

### BACKGROUND

In recent years, various high-speed communication techniques have been developed to meet the need for an improved communication speed. For example, a multilevel modulation method is a communication technique using a multilevel modulation signal in which a value of transmission data is assigned to plural signal levels. Optical communication systems with a transmission distance equal to or shorter than several tens of kilometers have mainly used an OOK (On-Off-Keying) method, in which transmission data made up of “0” and “1” is assigned to the presence or absence of a carrier wave. In recent years, use of a multilevel modulation method that makes it possible to increase the channel capacity compared to the OOK method has been studied, such as a 4-level PAM (Pulse Amplitude Modulation) method. In data transmission using the multilevel modulation method, a data signal is transmitted with a clock signal superimposed thereon, while on the receiving side, data identification is performed to identify the value of the transmission data at a timing synchronized with the recovered clock signal.

In the multilevel modulation method, as the multilevel number increases, it becomes more difficult to accurately perform data identification in a stabilized manner. To address this problem, a technique described in, for example, Patent Literature 1 improves the accuracy in data identification by inevitably changing the signal level of a multilevel modulation signal at every clock by encoding to increase the number of bits.

### CITATION LIST

### Patent Literature

Patent Literature 1: Japanese Patent Publication No. 4321297

### SUMMARY

### Technical Problem

However, the technique described in Patent Literature 1 has a problem that when frequency characteristics have dependency on signal levels, this leads to an increase in the number of occurrences of error in data identification of a multilevel modulation signal. Specifically, it is desirable to perform data identification in synchronization with an area with a greater extinction ratio between signal levels identified from one another. However, in a case where frequency characteristics have dependency on signal levels, the area with a greater extinction ratio between the signal levels shifts depending on the type of level transition. Accordingly, data identification timing is deviated which may lead to an increase in the number of occurrences of error in data identification.

The present invention has been achieved to solve the above problems, and an object of the present invention is to provide an optical receiver that is capable of accurately identifying data of a multilevel modulation signal.

### Solution to Problem

To solve the above problems and achieve the object, an optical receiver according to the present invention receives a multilevel modulation signal in which a value of transmission data is assigned to plural signal levels. The optical receiver includes a clock generator to generate a recovered clock signal from the multilevel modulation signal when the clock generator detects that a signal level of the multilevel modulation signal transitions between two median levels of the signal levels; and a data identifier to identify a value of the transmission data by using the generated recovered clock signal and the multilevel modulation signal.

### Advantageous Effects of Invention

According to the optical receiver of the present invention, there is an effect where it is possible to accurately identify data of a multilevel modulation signal.

### BRIEF DESCRIPTION OF DRAWINGS

FIG. 1 is a diagram illustrating a configuration of a multilevel communication system according to a first embodiment of the present invention.

FIG. 2 is a diagram illustrating an optimal rising edge and an optimal falling edge in a case where the multilevel communication system illustrated in FIG. 1 uses a PAM2 multilevel modulation signal.

FIG. 3 is a diagram illustrating an optimal rising edge and an optimal falling edge in a case where the multilevel communication system illustrated in FIG. 1 uses a PAM4 multilevel modulation signal.

FIG. 4 is a diagram illustrating characteristics of a multilevel modulation signal to be used in the multilevel communication system illustrated in FIG. 1 on a multilevel number-by-number basis.

FIG. 5 is a diagram illustrating a preferable data identification timing in a case where the multilevel communication system illustrated in FIG. 1 uses a PAM4 multilevel modulation signal.

FIG. 6 is a diagram illustrating a detailed configuration of an extraction circuit illustrated in FIG. 1.

FIG. 7 is a diagram illustrating a threshold to be input to level comparators illustrated in FIG. 6.

FIG. 8 is a diagram illustrating a configuration of an optical transmitter according to a second embodiment of the present invention.

### DESCRIPTION OF EMBODIMENTS

An optical receiver, an optical transmitter, a data identification method, and a multilevel communication system according to embodiments of the present invention will be described in detail below with reference to the accompanying drawings. The present invention is not limited to the embodiments.

### First Embodiment

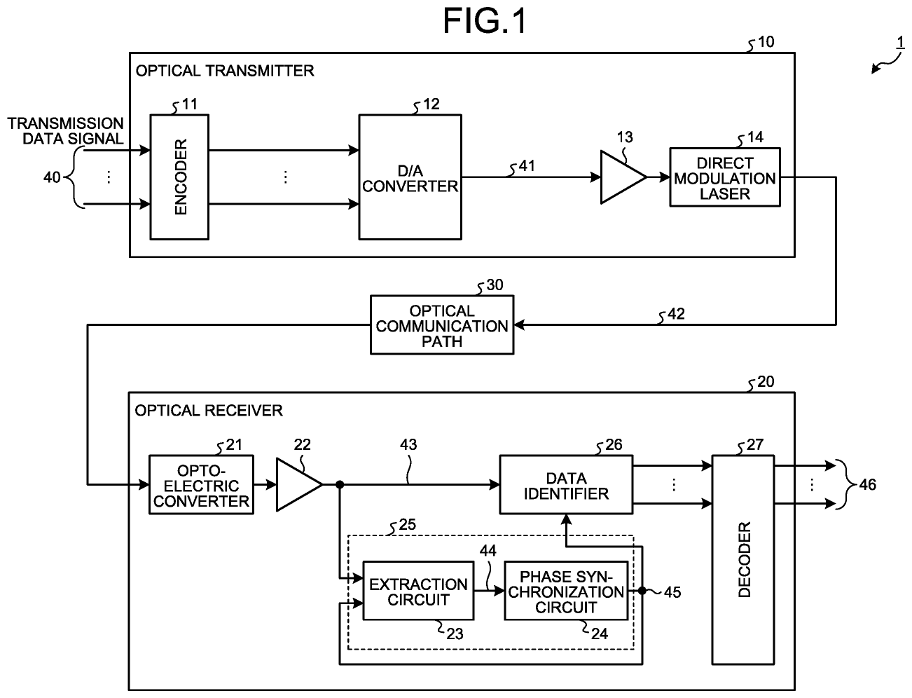

FIG. 1 is a diagram illustrating a configuration of a multilevel communication system 1 according to a first embodiment of the present invention. The multilevel communication system 1 includes an optical transmitter 10, an optical receiver 20, and an optical communication path 30 connecting the optical transmitter 10 and the optical receiver 20.

The optical transmitter 10 generates a transmission signal 42 from a transmission data signal 40 that is a digital signal indicating the value of transmission data. The transmission signal 42 is an optical signal that is a multilevel modulation signal in which the value of transmission data is assigned to plural signal levels. The optical transmitter 10 outputs the generated transmission signal 42 to the optical communication path 30. In a case of using a modulation method in which the multilevel number is m, the optical transmitter 10 sets log₂(m) bits of transmission data as a single unit to assign a single unit of the transmission data to m signal levels from a first level to an m-th level. Due to this operation, the transmission signal 42 is generated, which is a multilevel modulation signal in which the multilevel number is m. The multilevel number m is an integer equal to or larger than 2, and is also a multiplier of 2. That is, m=2ⁿ (n is an integer equal to or larger than 1).

The optical transmitter 10 includes an encoder 11, a D/A (Digital/Analog) converter 12, a semiconductor laser driver 13, and a direct modulation laser 14.

A plurality of transmission data signals 40 are input to the encoder 11. The encoder 11 encodes the input transmission data signals 40, and outputs the encoded transmission data signals 40. The encoded transmission data signals 40 are log₂(m)-bit digital signals. The D/A converter 12 receives the transmission data signals 40 output from the encoder 11, converts the transmission data signals 40 to an m-level PAM transmission signal 41 that is a multilevel modulation signal as an analog electric signal, and outputs the m-level PAM transmission signal 41. The semiconductor laser driver 13 receives the m-level PAM transmission signal 41 output from the D/A converter 12, converts the received m-level PAM transmission signal 41 to a signal with an electric-current amplitude appropriate to driving the direct modulation laser 14, and outputs the converted signal. The direct modulation laser 14 is also referred to as “DML”, and converts an electric signal to an optical signal and outputs the optical signal as the transmission signal 42. The transmission signal 42 is a multilevel modulation signal as an optical signal.

The optical communication path 30 includes: an optical fiber or a free space; an optical coupling lens; and a connector. The optical fiber is a single-mode fiber, a multimode fiber, or the like with a total length of several meters to several tens of meters. The optical fiber may be a single fiber or may be constituted of a plurality of fibers connected to each other.

The optical receiver 20: receives the transmission signal 42 that is a multilevel modulation signal from the optical transmitter 10 via the optical communication path 30; performs data identification on the received transmission signal 42; and outputs a reception data signal 46. The optical receiver 20 includes: an opto-electric converter 21; an amplifier 22; a clock generator 25 including an extraction circuit 23 and a phase synchronization circuit 24; a data identifier 26; and a decoder 27.

The opto-electric converter 21 is an element that converts a received optical signal to an electric-current signal and is, for example, a PD (Photo Diode). The amplifier 22 is a TIA (Trans-Impedance Amplifier) that converts the impedance of an electric-current signal obtained by opto-electric conversion to amplify the electric-current signal, and then outputs an m-level PAM reception signal 43 that is a voltage signal. The m-level PAM reception signal 43 output from the amplifier 22 is input to the extraction circuit 23 and the data identifier 26.

A multilevel modulation signal output from the amplifier 22, and a feedback signal that is a recovered clock signal output from the phase synchronization circuit 24 are input to the extraction circuit 23. On the basis of the signal level of the multilevel modulation signal, the extraction circuit 23 outputs the multilevel modulation signal or the feedback signal as an extracted signal 44. Detailed configuration of the extraction circuit 23 is described below.

The phase synchronization circuit 24 is an electronic circuit that outputs a signal whose phase is synchronized with an input signal. The phase synchronization circuit 24 is, for example, an electronic circuit referred to as “PLL (Phase Locked Loop)”. The phase synchronization circuit 24 executes feedback control on the basis of an input periodic signal, and outputs a signal whose phase is synchronized with an input signal from an oscillator. The extracted signal 44 having been output from the extraction circuit 23 is input to the phase synchronization circuit 24. The phase synchronization circuit 24 generates a recovered clock signal 45 whose phase is synchronized with the extracted signal 44. The recovered clock signal 45 is input to the data identifier 26, and is also input to the extraction circuit 23 as a feedback signal.

The extraction circuit 23 and the phase synchronization circuit 24 constitute the clock generator 25. When a predetermined condition is satisfied, the extraction circuit 23 outputs a multilevel modulation signal as the extracted signal 44. When a predetermined condition is not satisfied, the extraction circuit 23 outputs the recovered clock signal 45, having been fed back to the extraction circuit 23, as the extracted signal 44. Therefore, when a predetermined condition is satisfied, the clock generator 25 generates the recovered clock signal 45 from a multilevel modulation signal.

On the basis of the recovered clock signal 45, the data identifier 26 performs data identification to identify the value of transmission data from the signal level of the m-level PAM reception signal 43 that is a multilevel modulation signal. On the basis of the signal level of the PAM reception signal 43, the data identifier 26 identifies which value of the m values the transmission data indicates. For example, where m=4 and the m-level PAM reception signal 43 is a PAM4 signal, the data identifier 26 identifies the value of transmission data as any of the binary value “00”, “01”, “10”, or “11”. The decoder 27 decodes the data identified by the data identifier 26, and outputs the decoded data as the reception data signal 46.

The data identifier 26 determines the timing to identify the value of transmission data on the basis of the recovered clock signal 45. The recovered clock signal 45 is generated by detecting a rising edge or a falling edge of the m-level PAM reception signal 43 which appears during transition between the signal levels of the m-level PAM reception signal 43.

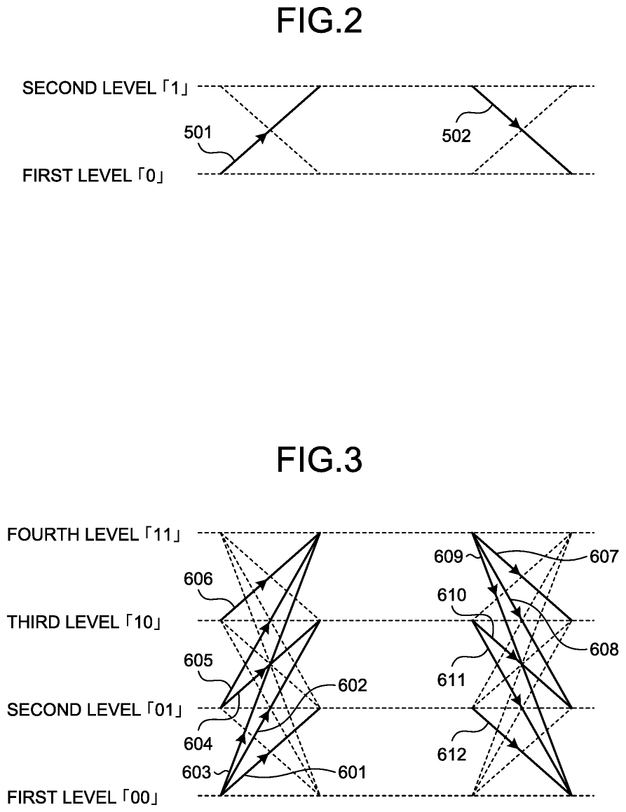

FIG. 2 is a diagram illustrating an optimal rising edge and an optimal falling edge in a case where the multilevel communication system 1 illustrated in FIG. 1 uses a PAM2 multilevel modulation signal. In a 2-level modulation method, the signal level of a multilevel modulation signal has a value of a first level or a value of a second level. The signal level is a voltage level, a power level, or the like. There is a possibility that the signal level may change in the course of processing or transmitting the signal. Each signal level is associated with one-bit value “0” or “1”. A rising edge 501 appears when the signal level transitions from the first level to the second level. A falling edge 502 appears when the signal level transitions from the second level to the first level.

FIG. 3 is a diagram illustrating an optimal rising edge and an optimal falling edge in a case where the multilevel communication system 1 illustrated in FIG. 1 uses a PAM4 multilevel modulation signal. In a 4-level modulation method, the signal level of a multilevel modulation signal has a value of a first level, a value of a second level, a value of a third level, or a value of a fourth level. Each signal level is associated with a two-bit value “00”, “01”, “10”, or “11”.

A rising edge 601 appears when the signal level transitions from the first level to the second level. A rising edge 602 appears when the signal level transitions from the first level to the third level. A rising edge 603 appears when the signal level transitions from the first level to the fourth level. A rising edge 604 appears when the signal level transitions from the second level to the third level. A rising edge 605 appears when the signal level transitions from the second level to the fourth level. A rising edge 606 appears when the signal level transitions from the third level to the fourth level. In addition, a falling edge 607 appears when the signal level transitions from the fourth level to the third level. A falling edge 608 appears when the signal level transitions from the fourth level to the second level. A falling edge 609 appears when the signal level transitions from the fourth level to the first level. A falling edge 610 appears when the signal level transitions from the third level to the second level. A falling edge 611 appears when the signal level transitions from the third level to the first level. A falling edge 612 appears when the signal level transitions from the second level to the first level.

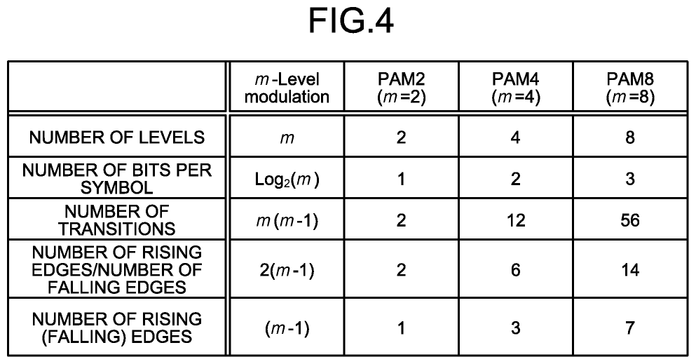

As understood from comparison between FIG. 2 and FIG. 3, as the multilevel number increases, the number of rising edges and falling edges increases. FIG. 4 is a diagram illustrating characteristics of a multilevel modulation signal to be used in the multilevel communication system 1 illustrated in FIG. 1 on a multilevel number-by-number basis. FIG. 4 illustrates the number of levels that is the number of signal levels that may be obtained, the number of bits per symbol, the number of transitions between signal levels, the number of rising edges and the number of falling edges, and the number of rising or falling edges.

Where m=2, the number of rising edges is one, while the number of falling edges is one. In contrast, where m=4, the number of rising edges is three, while the number of falling edges is three, and where m=8, the number of rising edges is seven, while the number of falling edges is seven. As the multilevel number increases, the number of respective edges both increase. Further, in an actual communication system, not only optimal level transitions, but also a larger number of edge patterns may be present due to the influence of nonlinearity or frequency characteristics of a direct modulation laser or an external modulation laser. Therefore, in the method using edge detection to generate the recovered clock signal 45, phase shifting of the edge may become a cause of phase shifting or phase fluctuations of the recovered clock signal. When phase shifting of the recovered clock signal occurs, the timing of data identification also deviates accordingly. This causes data to be erroneously identified as the preceding or subsequent symbol. This may result in an increase in the number of occurrences of bit error in the communication system.

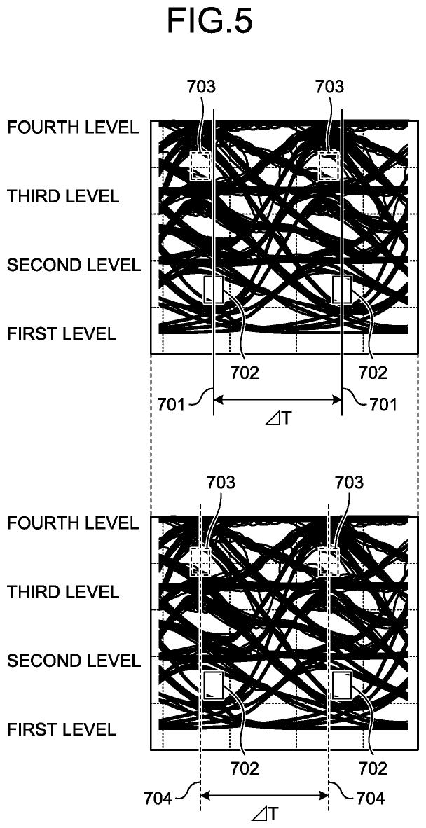

Even if there are no phase fluctuations of the recovered clock signal and the recovered clock cycle is constant, data identification may still be performed at an improper timing in some cases. FIG. 5 is a diagram illustrating a preferable data identification timing in a case where the multilevel communication system 1 illustrated in FIG. 1 uses a PAM4 multilevel modulation signal. FIG. 5 illustrates an eye diagram in which a large number of signal waveform transitions are sampled and overlapped one another. A timing 701, which is preferable for identification between the first level and the second level, is a timing at which an area 702 with a greater extinction ratio is present between the signal levels identified from one another. The timing 701, which is preferable for identification between the first level and the second level, is synchronous with the area 702 with a greater extinction ratio between the first level and the second level. However, the timing 701 is asynchronous to an area 703 with a greater extinction ratio between the third level and the fourth level. Similarly, a timing 704, which is preferable for identification between the third level and the fourth level, is synchronous with the area 703 with a greater extinction ratio between the third level and the fourth level. However, the timing 704 is asynchronous to the area 702 with a greater extinction ratio between the first level and the second level.

As described above, in a case where frequency characteristics have dependency on signal levels, an area with a greater extinction ratio between levels shifts depending on the type of level transition. Therefore, it is desirable to generate a recovered clock signal by detecting an edge that appears during transition between the median levels and that is an average of plural edge patterns that may be obtained.

As described above, in order to generate a recovered clock signal by detecting an edge appearing during transition between the median levels of plural signal levels that may be obtained by a multilevel modulation signal, when the clock generator 25 detects that a signal level of the multilevel modulation signal transitions between two median levels of plural signal levels, the clock generator 25 generates a recovered clock signal from the multilevel modulation signal.

When the extraction circuit 23 detects that a signal level of the multilevel modulation signal transitions between two median levels of plural signal levels, the extraction circuit 23 outputs the multilevel modulation signal as the extracted signal 44. When the extraction circuit 23 detects that a signal level of the multilevel modulation signal does not transition between two median levels of plural signal levels, the extraction circuit 23 outputs a feedback signal as the extracted signal 44.

In a case of a multilevel modulation signal in which transmission data is represented by m signal levels from the first level to the m-th level, two median signal levels refer to an “m/2”-th level and an “m/2+1”-th level. Specifically, in a case of a 4-level modulation signal, two median levels refer to the second level and the third level, while in a case of an 8-level modulation signal, two median levels refer to the fourth level and the fifth level. Detailed configuration of the extraction circuit 23 for implementing the functions as explained above is described below.

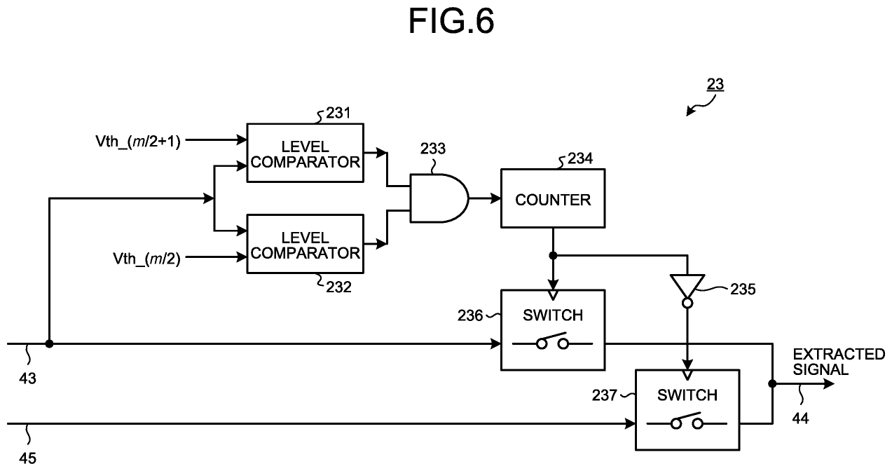

FIG. 6 is a diagram illustrating a detailed configuration of the extraction circuit 23 illustrated in FIG. 1. The extraction circuit 23 includes: two level comparators 231 and 232; a logical multiplication circuit 233; a counter 234; a logical inverting circuit 235; a switch 236; and a switch 237.

The m-level PAM reception signal 43 is input to the two level comparators 231 and 232. Each of the level comparators 231 and 232 compares the level of the m-level PAM reception signal 43 with a threshold Vth_(m/2) or a threshold Vth_(m/2+1), and then outputs a comparison result. Specifically, the level comparator 231 compares the m-level PAM reception signal 43 with the threshold Vth_(m/2+1), and outputs “1” when the signal level of the m-level PAM reception signal 43 is lower than the threshold Vth_(m/2+1). The level comparator 232 compares the m-level PAM reception signal 43 with the threshold Vth_(m/2), and outputs “1” when the signal level of the m-level PAM reception signal 43 is higher than the threshold Vth_(m/2).

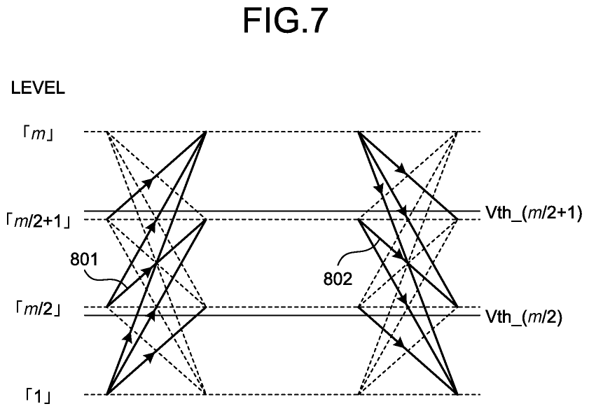

FIG. 7 is a diagram illustrating a threshold to be input to the level comparator 231 and the level comparator 232 illustrated in FIG. 6. The threshold Vth_(m/2+1) can be set as a signal level of m/2+1-th level. The threshold Vth_(m/2) can be set as a signal level of m/2-th level. The thresholds are set in this manner, so that when the m-level PAM reception signal 43 is in a state of transition between the m/2-th level and the m/2+1-th level, the level comparators 231 and 232 both output “1”. In order to allow tolerance, it is also possible that the threshold Vth_(m/2) can be set at a value of a signal level equal to or lower than the m/2-th level, and the threshold Vth_(m/2+1) can be set at a value of a signal level equal to or higher than the m/2+1-th level. In this case, a difference between the threshold Vth_(m/2) and the signal level of m/2-th level, and a difference between the threshold Vth_(m/2+1) and the signal level of m/2+1-th level need to be minimal enough to be determined as a tolerance.

It is also allowable to use a fixed value, which is optimized before the start of operation of the multilevel communication system 1, for each of the threshold Vth_(m/2) and the threshold Vth_(m/2+1). It is further allowable to use a variable value which can be adjusted during the operation as needed.

Referring back to the descriptions on FIG. 6, the logical multiplication circuit 233 is also referred to as “AND circuit”, and outputs a logical multiplication calculated from an output of the level comparator 231 and an output of the level comparator 232. The output of the logical multiplication circuit 233 is input to the counter 234. The counter 234 counts the duration of a state where an input signal is “ON”. During the period for which the duration is equal to or greater than a predetermined threshold, the counter 234 outputs a voltage needed for driving the switch 236 and the switch 237 as a switch control signal. The switch control signal output from the counter 234 is input to the switch 236 and the logical inverting circuit 235.

With the above configuration, the counter 234 outputs “1” as a switch control signal when a state, where the level comparator 231 and the level comparator 232 both output “1”, is maintained for a duration equal to or greater than a predetermined threshold. That is, the counter 234 outputs “1” when a state, where the value of the m-level PAM reception signal 43 is equal to or larger than the threshold Vth_(m/2) and equal to or smaller than the threshold Vth_(m/2+1), is maintained for a duration equal to or greater than a predetermined threshold.

The logical inverting circuit 235 logically inverts the switch control signal output from the counter 234, and inputs the logically-inverted switch control signal to the switch 237. Thus, when a signal input to the switch 236 is “1”, a signal input to the switch 237 becomes “0”, and when a signal input to the switch 236 is “0”, a signal input to the switch 237 becomes “1”.

Each of the switch 236 and the switch 237 has a function of connecting or disconnecting an input and an output in accordance with the value of an input signal. The switch 236 and the switch 237 are, for example, three-state buffer circuits. Specifically, when the value of an input signal is “1”, the switch 236 and the switch 237 are turned “ON” to connect an input and an output. When the value of an input signal is “0”, the switch 236 and the switch 237 are turned “OFF” to disconnect an input from an output. The switch 236 and the switch 237 output the extracted signal 44. The m-level PAM reception signal 43 is input to the switch 236. The recovered clock signal 45 having been fed back to the extraction circuit 23 is input to the switch 237.

With the above configuration, when a state, where the value of the m-level PAM reception signal 43 is equal to or larger than the threshold Vth_(m/2) and equal to or smaller than the threshold Vth_(m/2+1), is maintained for a duration equal to or greater than a predetermined threshold, then the switch 236 is brought into an “ON” state and the m-level PAM reception signal 43 is output as the extracted signal 44. When a state, where the value of the m-level PAM reception signal 43 is equal to or larger than the threshold Vth_(m/2) and equal to or smaller than the threshold Vth_(m/2+1), is not maintained for a duration equal to or greater than a predetermined threshold, then the switch 237 is brought into an “ON” state and the recovered clock signal 45 having been fed back to the extraction circuit 23 is output as the extracted signal 44. The extracted signal 44 is input to the phase synchronization circuit 24, and thereby the recovered clock signal 45 whose phase is synchronized with the extracted signal 44 is generated.

Accordingly, the configuration described above makes it possible to perform clock recovery on the basis of a rising edge 801 or a falling edge 802 that is an edge pattern appearing during the transition between the m/2-th level and the m/2+1-th level as illustrated in FIG. 7. An edge pattern appearing during the level transition between signal levels near the middle among plural signal levels is an average of all the edge patterns. This makes it possible to reduce the number of occurrences of error in data identification due to phase shifting of a recovered clock signal caused by the edge pattern.

In the present embodiment, the clock generator 25 includes the extraction circuit 23 and the phase synchronization circuit 24. However, the configuration described above is merely an example. It is sufficient that the clock generator 25 is configured to be capable of implementing the function of generating a recovered clock signal from a multilevel modulation signal, in which a value of transmission data is assigned to plural signal levels, when a signal level of the multilevel modulation signal transitions between two median levels of the plural signal levels.

### Second Embodiment

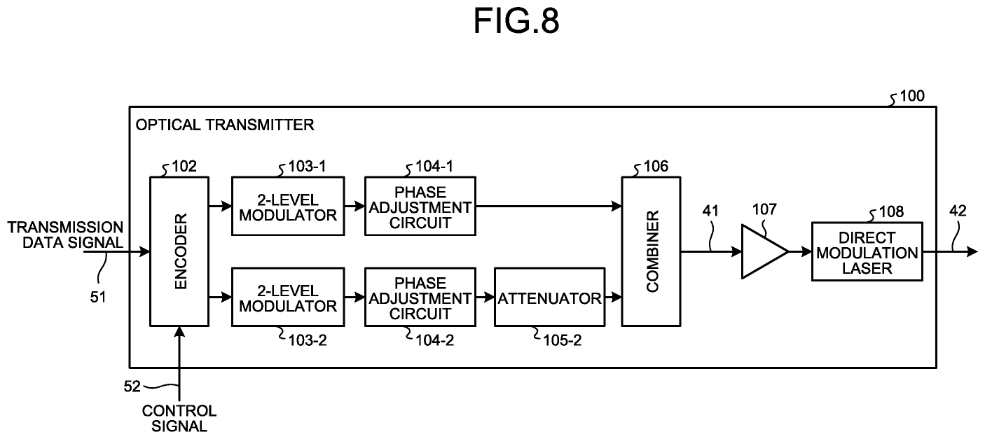

FIG. 8 is a diagram illustrating a configuration of an optical transmitter 100 according to a second embodiment of the present invention. The overall configuration of the multilevel communication system 1 according to the second embodiment is identical to that of the first embodiment except for a point that, in the second embodiment, an optical transmitter 100 is used instead of the optical transmitter 10 illustrated in FIG. 1, and thus explanations of the overall configuration are omitted.

The optical transmitter 100 includes: an encoder 102; a plurality of 2-level modulators 103; a plurality of phase adjustment circuits 104; a plurality of attenuators 105; a combiner 106; a semiconductor laser driver 107; and a direct modulation laser 108.

The optical transmitter 100 includes the 2-level modulators 103, where the number of the 2-level modulators 103 is log₂(m), corresponding to each bit of transmission data input from the encoder 102. In a case where a plurality of 2-level modulators 103 are distinguished from each other, these modulators are individually denoted as “2-level modulator 103-p”. p indicates the bit to which each of the 2-level modulators 103 corresponds. The 2-level modulator 103 corresponding to the highest-order bit is denoted as “2-level modulator 103-1”. The value of p becomes larger for a lower-order bit. p is a variable with a value that varies from 1 to log₂(m). FIG. 8 illustrates an example in which a PAM4 multilevel modulation signal is used. In this example, because log₂(m)=2, the optical transmitter 100 includes the 2-level modulator 103-1 and a 2-level modulator 103-2.

The optical transmitter 100 includes the phase adjustment circuits 104, where the number of the phase adjustment circuits 104 is log₂(m), and the attenuators 105, where the number of the attenuators 105 is log₂(m)−1. The log₂(m) phase adjustment circuits 104 are provided corresponding respectively to the log₂(m) 2-level modulators 103. The phase adjustment circuit 104 provided corresponding to the 2-level modulator 103-p is denoted as “phase adjustment circuit 104-p”. The attenuators 105 are provided corresponding respectively to the phase adjustment circuits 104 other than a phase adjustment circuit 104-1 among the phase adjustment circuits 104. The attenuator 105 provided corresponding to the phase adjustment circuit 104-p is denoted as “attenuator 105-p”. Because the optical transmitter 100 does not include an attenuator 105 where p=1, the value of p for the attenuator 105-p ranges from 2 to log₂(m).

Each of the 2-level modulators 103 outputs a signal with a value of a first level or a signal with a value of a second level larger than the value of the first level. For example, the value of the first level is “0”, and the value of the second level is “1”. The optical transmitter 100 combines outputs of a plurality of 2-level modulators 103 to generate the m-level PAM transmission signal 41. Where the output amplitude of the 2-level modulator 103-1 that is the 2-level modulator 103 corresponding to the highest-order bit is defined as 1-fold, the attenuation amount of the attenuator 105 is set in such a manner that the amplitude becomes smaller for a lower-order bit to a 0.5-fold, 0.25-fold, 0.125-fold increase, and the like. That is, the attenuation amount of the attenuator 105 is increased as the attenuator 105 corresponds to a lower-order bit. Therefore, the attenuation amount of the attenuator 105-p can be increased as the value of p becomes larger. For example, the attenuation amount of the attenuator 105-p can be calculated as a voltage of approximately 6×(p−1) dB. Due to this setting, among the output amplitudes of the 2-level modulators 103-1 to 103-log₂(m), the output amplitude of the 2-level modulator 103-1 becomes maximum, while the output amplitude of the 2-level modulator 103-log₂(m) becomes minimum.

Specifically, where m=8 and a PAM8 modulation signal is used, then log₂(m)=3 and thus the optical transmitter 100 includes two attenuators 105 including an attenuator 105-2 and an attenuator 105-3. In this case, the attenuation amount of the attenuator 105-2 is calculated as 6×(2−1)=6 dB where p=2, so that a voltage amplitude can be obtained which is one-half of the output amplitude of the phase adjustment circuit 104-1. The attenuation amount of the attenuator 105-3 is calculated as 6×(3−1)=12 dB where p=3, so that a voltage amplitude can be obtained which is one-fourth of the output amplitude of the phase adjustment circuit 104-1.

Further, where m=16 and a PAM16 modulation signal is used, then log₂(m)=4 and thus the optical transmitter 100 includes three attenuators 105 including the attenuator 105-2, the attenuator 105-3, and an attenuator 105-4. In this case, the attenuation amount of the attenuator 105-2 is calculated as 6 dB where p=2, so that a voltage amplitude can be obtained which is one-half of the output amplitude of the phase adjustment circuit 104-1. The attenuation amount of the attenuator 105-3 is calculated as 12 dB where p=3, so that a voltage amplitude can be obtained which is one-fourth of the output amplitude of the phase adjustment circuit 104-1. The attenuation amount of the attenuator 105-4 is calculated as 18 dB where p=4, so that a voltage amplitude can be obtained which is one-eighth of the output amplitude of the phase adjustment circuit 104-1.

The phase adjustment circuit 104 and the attenuator 105 are used to shape the m-level PAM transmission signal 41. It is possible that a part or all of the phase adjustment circuit 104 and the attenuator 105 are omitted.

A transmission data signal 51 that is input to the optical transmitter 100 is input to the encoder 102. The encoder 102 encodes the transmission data signal 51 to generate transmission data. The transmission data generated by the encoder 102 is input on a bit-by-bit basis to the 2-level modulator 103 corresponding to each bit. A plurality of 2-level modulators 103 individually modulate the input data to a binary signal, and outputs the binary-modulated signal, that is, a first level signal or a second level signal to the phase adjustment circuit 104. The phase adjustment circuit 104 adjusts the phase of an input signal such that the phase of the m-level PAM transmission signal 41, which is output from the combiner 106 and then input to the semiconductor laser driver 107, is appropriate to driving the semiconductor laser driver 107. The phase adjustment circuit 104 then outputs the signal with its phase adjusted to the attenuator 105. The attenuator 105 adjusts the amplitude of an input signal such that the amplitude of the m-level PAM transmission signal 41, which is output from the combiner 106 and then input to the semiconductor laser driver 107, is appropriate to driving the semiconductor laser driver 107. The combiner 106 combines outputs of the 2-level modulators 103 after having been adjusted by the phase adjustment circuit 104 and the attenuator 105 to generate the m-level PAM transmission signal 41, and then outputs the generated m-level PAM transmission signal 41.

A control signal 52 is input to the encoder 102 from outside in a given cycle. The control signal 52 is a signal for instructing the optical transmitter 100 to bring the signal level of the transmission signal 42, output from the optical transmitter 100, into a state of repeated transition between two median levels of plural signal levels. When the control signal 52 is input to the encoder 102, the encoder 102 outputs the control signal 52 directly as transmission data, instead of the transmission data signal 51. The value of transmission data corresponding to one of the two median levels of plural signal levels is made up of “0” as the highest-order bit and “1” as a bit lower than the highest-order bit. Also, the value of transmission data corresponding to the other median level is made up of “1” as the highest-order bit and “0” as a bit lower than the highest-order bit. Specifically, where m=4, the values of transmission data corresponding to two median levels are “01” and “10”. Where m=8, the values of transmission data corresponding to two median levels are “011” and “100”. Where m=16, the values of transmission data corresponding to two median levels are “0111” and “1000”. Thus, it is allowable that the control signal 52 is transmission data in which the value of the highest-order bit alternately becomes “0” and “1”, and accordingly bits lower than the highest-order bit become a value different from the value of the highest-order bit.

Therefore, when the control signal 52 described above is input to the encoder 102, the 2-level modulator 103-1, which outputs the maximum amplitude among a plurality of 2-level modulators 103 and which is thus the maximum 2-level modulator corresponding to the highest-order bit, outputs a first level signal and a second level signal alternately. The 2-level modulators 103 other than the maximum 2-level modulator output a second level signal when the maximum 2-level modulator outputs a first level signal, and also output a first level signal when the maximum 2-level modulator outputs a second level signal. The combiner 106 combines outputs of a plurality of 2-level modulators 103 to generate the m-level PAM transmission signal 41. Due to this operation, the signal level of the m-level PAM transmission signal 41, generated while the control signal 52 is input, repeatedly transitions between two median levels of plural signal levels.

The m-level PAM transmission signal 41 output from the combiner 106 is input to the semiconductor laser driver 107. The semiconductor laser driver 107 converts the m-level PAM transmission signal 41 to an electric current with an amplitude appropriate to driving the direct modulation laser 108. The direct modulation laser 108 converts an electric signal to an optical signal to generate the transmission signal 42, and outputs the generated transmission signal 42.

With the above configuration, the optical transmitter 100 is capable of generating the transmission signal 42 that is a multilevel modulation signal, where the multilevel number is m, in which level transition between the m/2+1-th level and the m/2-th level occurs in a given cycle. Due to this operation, the optical receiver 20 having received this transmission signal 42 generates the recovered clock signal 45 during a pull-in time for which a signal level of the multilevel modulation signal repeatedly transitions between two median levels of plural signal levels. This can facilitate clock recovery on the basis of an edge pattern appearing during the level transition between the m/2+1-th level and the m/2-th level.

The configurations described in the above embodiments are only examples of the content of the present invention. The configurations can be combined with other well-known techniques, and part of each of the configurations can be omitted or modified without departing from the scope of the present invention.

### REFERENCE SIGNS LIST

1 multilevel communication system, 10, 100 optical transmitter, 11, 102 encoder, 12 D/A converter, 13, 107 semiconductor laser driver, 14, 108 direct modulation laser, 20 optical receiver, 21 opto-electric converter, 22 amplifier, 23 extraction circuit, 24 phase synchronization circuit, 25 clock generator, 26 data identifier, 27 decoder, 30 optical communication path, 40, 51 transmission data signal, 41 m-level PAM transmission signal, 42 transmission signal, 43 m-level PAM reception signal, 44 extracted signal, 45 recovered clock signal, reception data signal, 52 control signal, 103, 103-1, 103-2, 103-p 2-level modulator, 104, 104-1, 104-2, 104-p phase adjustment circuit, 105, 105-2, 105-p attenuator, 106 combiner, 501, 601, 602, 603, 604, 605, 606, 801 rising edge, 502, 607, 608, 609, 610, 611, 612, 802 falling edge.

1. An optical receiver to receive a multilevel modulation signal in which a value of transmission data is assigned to plural signal levels, the optical receiver comprising:
a clock generator to generate a recovered clock signal from the multilevel modulation signal when the clock generator detects that a signal level of the multilevel modulation signal transitions only between two median levels of the signal levels; and
a data identifier to identify a value of the transmission data by using the generated recovered clock signal and the multilevel modulation signal.

2. The optical receiver according to claim 1, wherein the clock generator generates the recovered clock signal during a pull-in time for which a signal level of the multilevel modulation signal repeatedly transitions between two median levels of the signal levels.

3. The optical receiver according to claim 1, wherein
the clock generator includes:
an extraction circuit to output the multilevel modulation signal or a feedback signal as an extracted signal, and
a phase synchronization circuit to output the recovered clock signal that is a signal whose phase is synchronized with the extracted signal, and
when the extraction circuit detects that a signal level of the multilevel modulation signal repeatedly transitions between two median levels of the signal levels, the extraction circuit outputs the multilevel modulation signal as the extracted signal, and when a signal level of the multilevel modulation signal does not repeatedly transition between two median levels of the signal levels, the extraction circuit outputs the feedback signal as the extracted signal.

4. An optical transmitter connected to the optical receiver according to claim 1 through an optical communication path, the optical transmitter comprising:
a plurality of 2-level modulators, each of which corresponds to each of bits of transmission data, and outputs a signal with a value of a first level or a signal with a value of a second level larger than the value of the first level; and
a combiner to combine outputs of the 2-level modulators to generate a multilevel modulation signal, wherein
among the 2-level modulators, a maximum 2-level modulator corresponding to a highest-order bit outputs a value of the first level and a value of the second level alternately on a basis of a control signal to be input in a given cycle, and among the 2-level modulators, the 2-level modulators other than the maximum 2-level modulator output a value of a different level from the maximum 2-level modulator.

5. A data identification method comprising:
receiving a multilevel modulation signal in which a value of transmission data is assigned to plural signal levels;
generating a recovered clock signal from the multilevel modulation signal when a signal level is detected to repeatedly transition only between two median levels of the signal levels; and
identifying a value of the transmission data by using the generated recovered clock signal and the multilevel modulation signal.

6. A multilevel communication system comprising:
an optical transmitter to generate and transmit a multilevel modulation signal in which a value of transmission data is assigned to plural signal levels; and
an optical receiver to generate a recovered clock signal from the multilevel modulation signal when the optical receiver detects that a signal level repeatedly transitions only between two median levels of the signal levels on a basis of the multilevel modulation signal received from the optical transmitter, and to identify a value of the transmission data by using the generated recovered clock signal and the multilevel modulation signal.

7. The optical receiver according to claim 2, wherein
the clock generator includes:
an extraction circuit to output the multilevel modulation signal or a feedback signal as an extracted signal, and
a phase synchronization circuit to output the recovered clock signal that is a signal whose phase is synchronized with the extracted signal, and
when the extraction circuit detects that a signal level of the multilevel modulation signal repeatedly transitions between two median levels of the signal levels, the extraction circuit outputs the multilevel modulation signal as the extracted signal, and when a signal level of the multilevel modulation signal does not repeatedly transition between two median levels of the signal levels, the extraction circuit outputs the feedback signal as the extracted signal.

8. An optical transmitter connected to the optical receiver according to claim 2 through an optical communication path, the optical transmitter comprising:
a plurality of 2-level modulators, each of which corresponds to each of bits of transmission data, and outputs a signal with a value of a first level or a signal with a value of a second level larger than the value of the first level; and
a combiner to combine outputs of the 2-level modulators to generate a multilevel modulation signal, wherein
among the 2-level modulators, a maximum 2-level modulator corresponding to a highest-order bit outputs a value of the first level and a value of the second level alternately on a basis of a control signal to be input in a given cycle, and among the 2-level modulators, the 2-level modulators other than the maximum 2-level modulator output a value of a different level from the maximum 2-level modulator.

9. An optical transmitter connected to the optical receiver according to claim 3 through an optical communication path, the optical transmitter comprising:
a plurality of 2-level modulators, each of which corresponds to each of bits of transmission data, and outputs a signal with a value of a first level or a signal with a value of a second level larger than the value of the first level; and
a combiner to combine outputs of the 2-level modulators to generate a multilevel modulation signal, wherein
among the 2-level modulators, a maximum 2-level modulator corresponding to a highest-order bit outputs a value of the first level and a value of the second level alternately on a basis of a control signal to be input in a given cycle, and among the 2-level modulators, the 2-level modulators other than the maximum 2-level modulator output a value of a different level from the maximum 2-level modulator.

10. An optical transmitter connected to the optical receiver according to claim 7 through an optical communication path, the optical transmitter comprising:
a plurality of 2-level modulators, each of which corresponds to each of bits of transmission data, and outputs a signal with a value of a first level or a signal with a value of a second level larger than the value of the first level; and
a combiner to combine outputs of the 2-level modulators to generate a multilevel modulation signal, wherein
among the 2-level modulators, a maximum 2-level modulator corresponding to a highest-order bit outputs a value of the first level and a value of the second level alternately on a basis of a control signal to be input in a given cycle, and among the 2-level modulators, the 2-level modulators other than the maximum 2-level modulator output a value of a different level from the maximum 2-level modulator.
